(19) United States
(12) Patent Application Publication
(10) Pub. No.: US 2008/0260095 A1
(43) Pub. Date: Oct. 23, 2008

(54) METHOD AND APPARATUS TO REPEATABLY ALIGN A CT SCANNER

(76) Inventors: Predrag Sukovic, Birmingham, MI (US); William C. Van Kampen, Saline, MI (US); Joseph Webster Stayman, Ann Arbor, MI (US); Miodrag Rakic, Redondo Beach, CA (US); James A. Bertolina, Portage, MI (US); James F. O'Connell, Ann Arbor, MI (US); David Phillipe Sarment, Ann Arbor, MI (US); Neal Clinthorne, Ann Arbor, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/103,967

(22) Filed: Apr. 16, 2008

Related U.S. Application Data
(60) Provisional application No. 60/911,922, filed on Apr. 16, 2007.

(51) Int. Cl. H05G 1/60

(52) U.S. Cl. 378/20

(57) ABSTRACT

A CT scanner includes a gantry including a first arm and a second arm. The first arm houses an x-ray source that generate x-rays, and the second arm houses a complementary flat-panel detector. During a pre-operative CT scan, the CT scanner is positioned at a scanning position near the patient. An alignment feature ensures that the CT scanner is repeatably positionable in the scanning position. After the pre-operative scan is complete, the CT scanner is moved to a remote position. If an updated CT scan is needed during the surgical procedure, the CT scanner is moved from the remote position to the scanning position. The alignment feature ensures that the CT scanner is properly positioned in the scanning position.

### REFERENCE TO RELATED APPLICATIONS

This application claims priority to U.S. Provisional Application No. 60/911,922 filed Apr. 16, 2007.

### BACKGROUND OF THE INVENTION

The present invention relates generally to a CT scanner that is repeatably alignable in a position during a surgical procedure.

A CT scanner takes a plurality of x-ray images of a part of a patient to generate a three-dimensional CT image. For an image-guided surgical procedure, a pre-operative CT scan is taken before the surgical procedure to create a pre-operative CT image. During the pre-operative CT scan, the CT scanner is located in a scanning position. After the pre-operative CT scan is complete, the CT scanner is moved to a remote position to provide additional space in the surgical area.

During the surgical procedure, the relevant area of the patient may shift, which can introduce variations into the surgical procedure. A partial CT scan of a volume of interest of the patient may be taken during the surgical procedure to update the pre-operative CT scan to form an updated CT image.

When the partial CT scan is obtained, the CT scanner should be located in the same position relative to the patient as it was located during the pre-operative CT scan. In prior surgical procedures, this location is estimated. Therefore, it is possible that the CT scanner is not located in the exact same position relative to the patient as it was located during the pre-operative CT scan.

### SUMMARY OF THE INVENTION

A CT scanner includes a gantry including a first arm and a second arm. A first arm houses an x-ray source that generate x-rays, and a second arm houses a complementary flat-panel x-ray detector. As the gantry rotates about a patient, the x-ray detector obtains a plurality of x-ray images at a plurality of rotational positions which are used to generate a three-dimensional CT image.

A pre-operative CT scan of the patient is performed before a surgical procedure. The CT scanner is positioned at a scanning position near the patient. The CT scanner includes an alignment feature that ensures that the CT scanner is repeatably positionable in the scanning position. After the pre-operative scan, the CT scanner is moved to a remote position to provide additional space in the surgical area.

During the surgical procedure, if an updated CT scan is needed, the CT scanner is moved from the remote position to the scanning position. The alignment feature ensures that the CT scanner is positioned in the scanning position. That is, the CT scanner is positioned in the same position as it was positioned during the pre-operative CT scan. An updated CT scan can then be performed.

These and other features of the present invention will be best understood from the following specification and drawings.

### BRIEF DESCRIPTION OF THE DRAWINGS

Other advantages of the present invention can be understood by reference to the following detailed description when considered in connection with the accompanying drawings wherein:

FIG. 1 illustrates a first embodiment CT scanner;

FIG. 2 illustrates the CT scanner of FIG. 1 with a part of a patient received in the CT scanner;

FIG. 3 illustrates a second embodiment CT scanner;

FIG. 4 illustrates a computer employed with the CT scanner;

FIG. 5 illustrates an operating room including a CT scanner with an alignment feature that allows the CT scanner to be repeatably alignable in a scanning position;

FIG. 6 illustrates a first full field of view of a two-dimensional image;

FIG. 7 illustrates a second full field of view of a two-dimensional image;

FIG. 8 illustrates a field of view of a two-dimensional image taken with a collimated x-ray source to focus on a volume of interest;

FIG. 9 illustrates an operating room including a CT scanner that is repeatably alignable using a laser;

FIG. 10 illustrates an operating room including a CT scanner that is repeatably alignable using a motor;

FIG. 11 illustrates an operating room including a CT scanner that is repeatably alignable using a mechanical interlock;

FIG. 12 illustrates an operating room including a CT scanner that is repeatably alignable using a sensor; and

FIG. 13 illustrates a two dimensional x-ray image taken with a CT scanner that is used to align the CT scanner.

### DETAILED DESCRIPTION OF THE PREFERRED EMBODIMENT

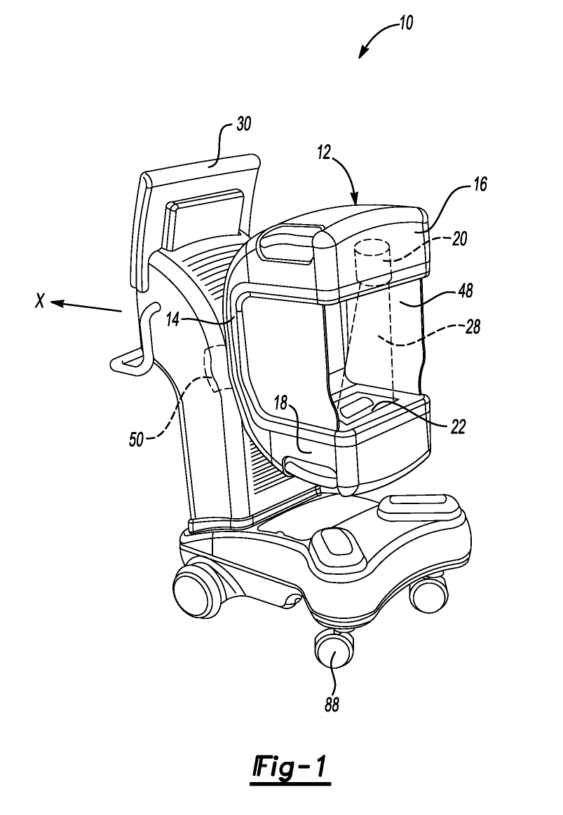

FIG. 1 illustrates a CT scanner 10 of the present invention. The CT scanner 10 includes a gantry 12 that supports and houses components of the CT scanner 10. In one example, the gantry 12 includes a cross-bar section 14, and a first arm 16 and a second arm 18 each extend substantially perpendicularly from opposing ends of the cross-bar section 14 to form a gantry 12 that is c-shaped. The first arm 16 houses an x-ray source 20 that generate x-rays 28. In one example, the x-ray source 20 is a cone-beam x-ray source. The second arm 18 houses a complementary flat-panel x-ray detector 22. The x-rays 28 are directed toward the x-ray detector 22 which includes a converter (not shown) that converts the x-rays 28 from the x-ray source 20 to visible light, and an array of photodetectors behind the converter create an image. As the gantry 12 rotates about a patient P, the x-ray detector 22 obtains a plurality of x-ray images at a plurality of rotational positions. Various configurations and types of x-ray sources 20 and x-ray detectors 22 can be utilized, and the invention is largely independent of the specific technology used for the CT scanner 10.

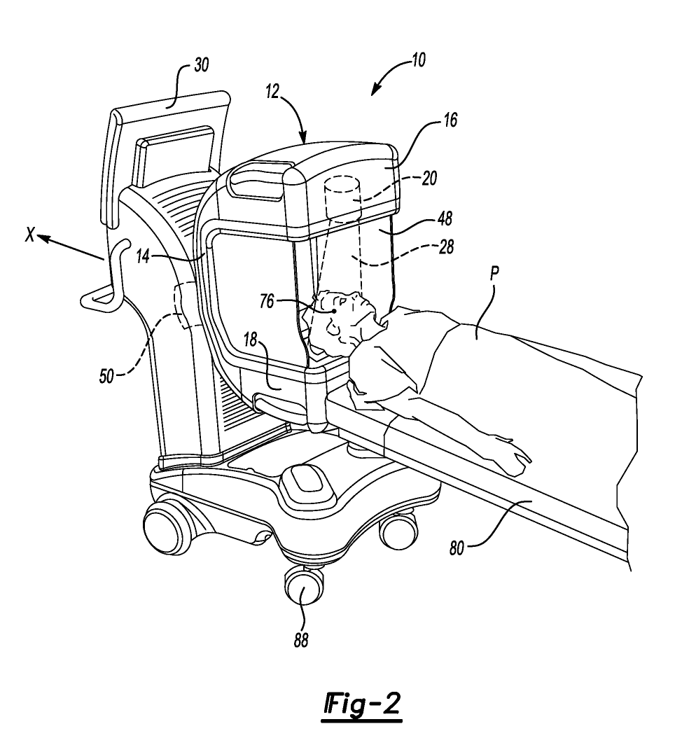

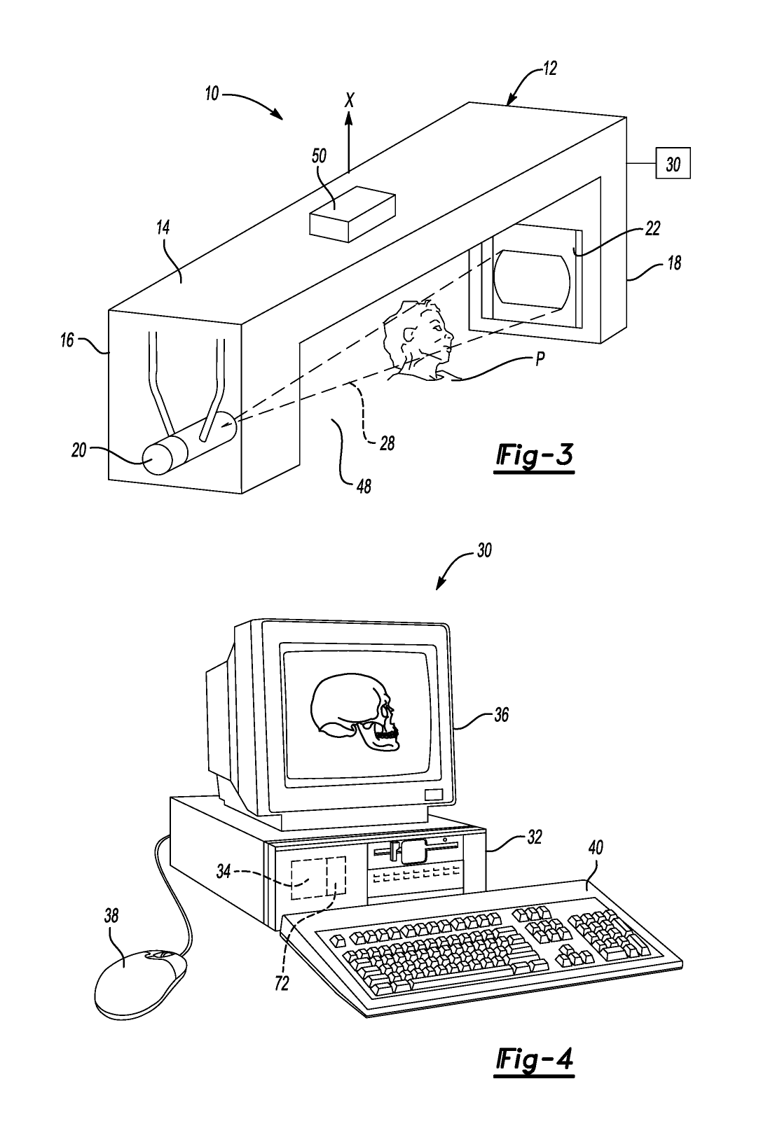

FIG. 2 illustrates the CT scanner 10 with a part of a patient P received in a space 48 between the first arm 16 and the second arm 18. A motor 50 rotates the gantry 12 about an axis of rotation X, and a plurality of x-ray images of the patient P are obtained at the plurality of rotational positions. The axis of rotation X is positioned between the x-ray source 20 and the x-ray detector 22. The gantry 12 can be rotated approximately slightly more than 360° about the axis of rotation X. In one example, as shown in FIGS. 1 and 2, the axis of rotation X is substantially horizontal, and the patient P is typically lying down on a table 80. Alternatively, as shown in FIG. 3, the axis of rotation X is substantially vertical, and the patient P is sitting upright. The CT scanner 10 also includes a plurality of wheels 88 that allow the CT scanner 10 to be moved.

As shown schematically in FIG. 4, the CT scanner 10 further includes a computer 30 having a microprocessor or CPU 32, a storage 34 (memory, hard drive, optical, and/or magnetic, etc), a display 36, a mouse 38, a keyboard 40 and other hardware and software for performing the functions described herein. The computer 30 powers and controls the x-ray source 20 and the motor 50. The plurality of x-ray images obtained by the x-ray detector 22 are provided to the computer 30. The computer 30 generates a three-dimensional CT image from the plurality of x-ray images utilizing any known techniques and algorithms. The three-dimensional CT image is stored on the storage 34 of the computer 30 and can be displayed on the display 36 for viewing or manipulation.

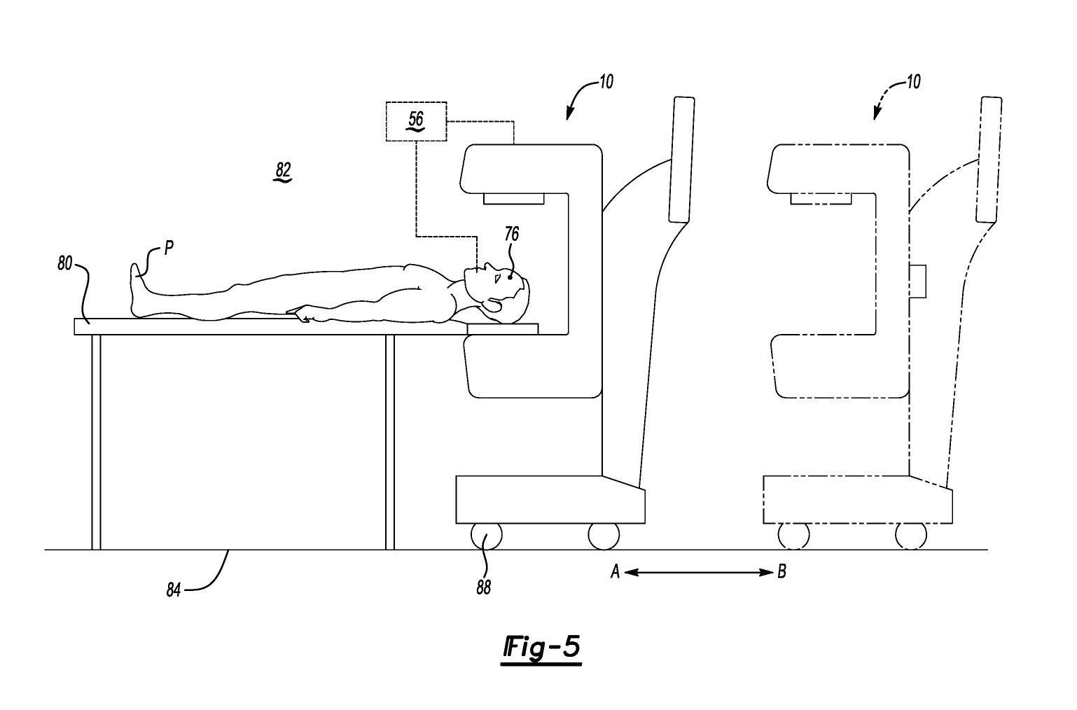

Prior to a surgical procedure, a pre-operative CT scan of the patient P is performed and pre-operative data is stored on the computer 30. During the pre-operative CT scan, the CT scanner 10 is positioned at a scanning position A near the patient P, as shown in FIG. 5. The CT scanner 10 includes an alignment feature 56 (shown schematically) that retains the CT scanner 10 in the scanning position A and ensures that the CT scanner 10 is repeatably positionable in the scanning position A. Therefore, if any CT scans are needed during the surgical procedure, the CT scanner 10 can be positioned in exactly the scanning position A, ensuring repeatability of each CT scan.

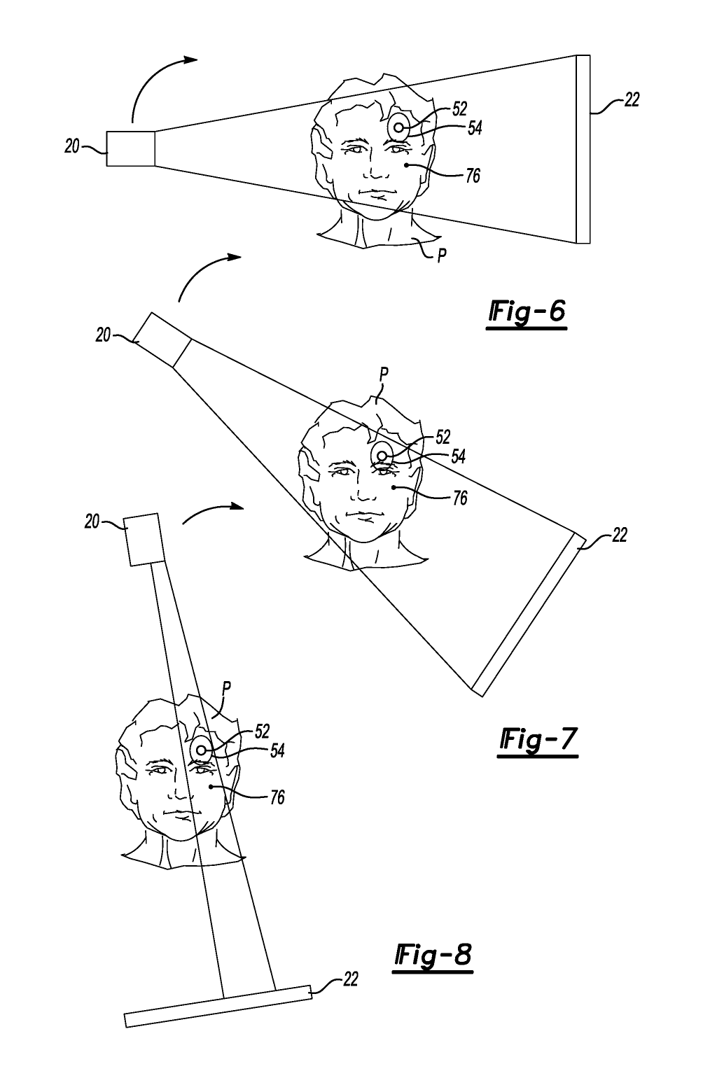

As shown in FIGS. 6 to 8, a volume of interest 54 is defined as an area 52 of the patient P where a surgeon is working, plus some margin. The pre-operative data may be a complete three-dimensional CT image or model of an area surrounding and including the volume of interest 54 of the patient P or a partial three-dimensional CT image of the volume of interest 54. The pre-operative data is used only for background information and calculations required in creating a new image (as described below) and has less importance in the new image than intra-operative data taken during the surgical procedure. After the pre-operative CT scan is obtained, the CT scanner 10 is moved from the scanning position A to a remote position B, and the surgical procedure can begin or continue.

During the surgical procedure, an updated CT scan may be needed to evaluate or determine the progress of the surgical procedure. The CT scanner 10 is moved from the remote position B to the scanning position A. The alignment feature 56 ensures that the CT scanner 10 is properly positioned in the scanning position A (the same position the CT scanner 10 was located during the pre-operative CT scan).

Once the CT scanner 10 is returned to the scanning position A, the surgeon can request (using a graphical or voice-activated user interface on the computer 30) a fully automatic update CT scan or a manually designated CT scan of the volume of interest 54.

During the updated CT scan, the CT scanner 10 takes a partial intra-operative CT scan of the volume of interest 54 of the patient P so the surgeon can evaluate or determine the progress of the surgical procedure (e.g., has a tumor been completely removed or has a sinus cavity been completely repaired). The computer 30 uses the pre-operative data (CT, MRI or generic) of the areas surrounding the volume of interest 54 in conjunction with the new intra-operative data obtained from the intra-operative CT scan of the volume of interest 54 to generate an updated intra-operative three-dimensional CT image. Therefore, a full intra-operative CT scan is not required. Only the volume of interest 54 is scanned, reducing the dosage of x-rays experienced by the patient P.

The CT scanner 10 takes a plurality of two-dimensional images (initial images) of the patient P at a plurality of angularly separated positions about the patient P using a full field of view (two are shown in FIGS. 6 and 7, although more images could be used). The plurality of positions may be the same angularly spaced positions used in the full pre-operative CT scan or the positions may be separated by much larger angles. The CT scanner 10 takes a downsampled image approximately 180° around the patient P and a non-downsampled image at the other approximately 180° around the patient P.

Downsampling includes any of several methods for reducing a resolution of the information from the x-ray detector 22. One way of downsampling is to simply ignore a certain percentage of the pixels and only sample, for example, every other pixel or every third pixel, etc. Another way of downsampling is to first average together the signal from adjacent pixels, such as an adjacent pair or a small array of four or more pixels, and then to treat it as a single pixel of information. Information from adjacent pixels can be statistically combined in many different ways besides averaging. The amount of downsampling (or not downsampling at all) can be varied by the CT scanner 10. The amount of downsampling (in other words, the resolution of the image) can even be varied within an image, as controlled by the computer 30, such that selected areas of the image are at a higher resolution than the remainder of the image. In this manner, for example, a volume of interest within the image can be recorded at a high resolution, without unnecessarily increasing the image file size for the entire image. Varying the resolution of the image can be used in several different ways.

When a fully automatic updated CT scan is requested, the CT scanner 10 registers its location relative to the patient P (who may have moved during the surgical procedure), the volume of interest 54 and the pre-operative CT scan based upon the initial images. This can be done by locating and orienting some known structure in part of the patient's P anatomy in the initial images (e.g., employing a marker 76, shown in FIG. 2). The CT scanner 10 compares the initial images to the pre-operative CT scan. Based upon the comparison, the CT scanner 10 determines where changes to the patient's P anatomy have occurred (e.g., because of the surgical procedure so far). The region where changes have occurred, plus some defined margin, is the volume of interest 54.

The location of the volume of interest 54 can also be manually selected on the pre-operative CT image using software on the computer 30. The surgeon can select the volume of interest 54 using the mouse 38. The CT scanner 10 then determines and registers the location of the volume of interest 54 relative to the patient P.

As shown in FIG. 8, after the volume of interest 54 is located on the downsampled initial images, the x-ray source 20 is collimated and a CT scan of the volume of interest 54 is taken. As the x-ray source 20 is collimated, the patient P is exposed to less x-rays. The CT scanner 10 takes a plurality of images at a plurality of angularly-spaced positions while the x-ray source 20 collimated. For example, between two and ten initial images could be taken over approximately 45°.

The CT scanner 10 then automatically (i.e., without further prompting or input) displays the volume of interest 54 on the display 36. If more than one volume of interest 54 is selected, the CT scanner 10 marks the locations of the volume of interest 54 such that the surgeon can easily toggle or scroll between the volume of interest 54.

The pre-operative data and the intra-operative data are correlated to generate an updated three-dimensional CT image. That is, the intra-operative data obtained from the partial intra-operative CT scan is used to update the corresponding information in the pre-operative three-dimensional CT image.

When taking the updated partial CT three-dimensional image, the alignment feature 56 ensures that the CT scanner 10 is repeatably aligned in the scanning position A, allowing consistent CT scans of an area of the patient P.

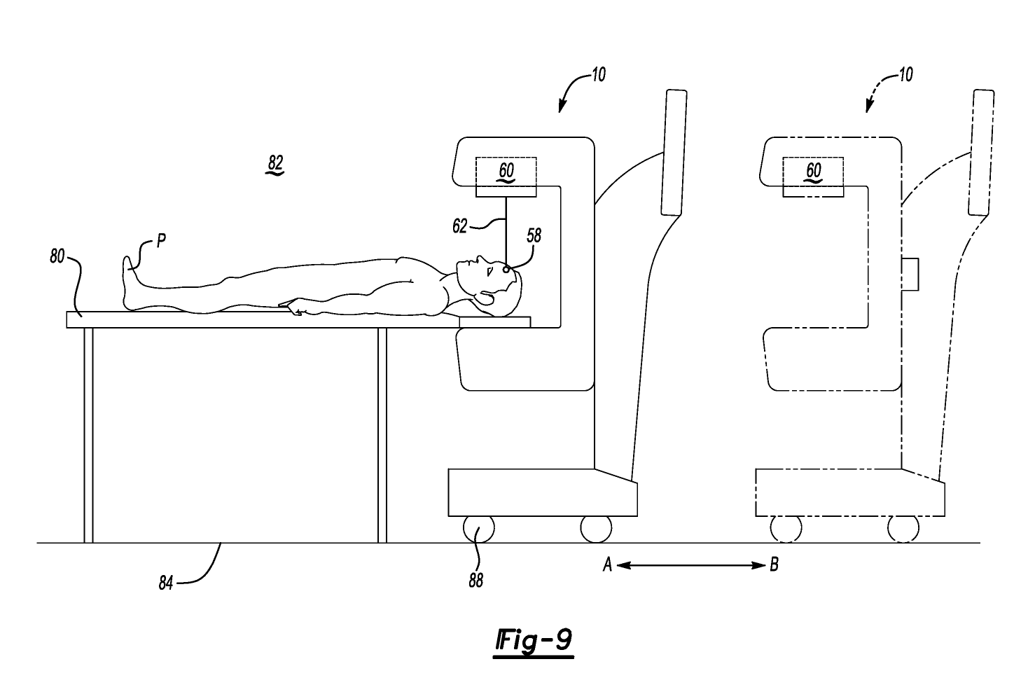

As shown in FIG. 9, in a first example, a marking 58 (such as a mark or a drape) is located on the patient P. A laser generating device 60 is mounted on the CT scanner 10. During the pre-operative CT scan when the CT scanner 10 is positioned in the scanning position A, the laser generating device 60 generates a laser beam 62 that is directed towards the patient P. The marking 58 on the patient P indicates where the laser beam 62 contacts the patient P. In another example, the laser beam 62 aligns with a hole when the CT scanner 10 is in the scanning position A. After the pre-operative CT scan is obtained, the CT scanner 10 is moved away from the patient P to the remote position B. If an updated partial CT scan is needed during the surgical procedure, the CT scanner 10 is again moved to the scanning position A. When the laser beam 62 aligns with the marking 58 or the hole, this indicates that the CT scanner 10 is properly aligned and located in the scanning position A. An updated CT scan can then be obtained.

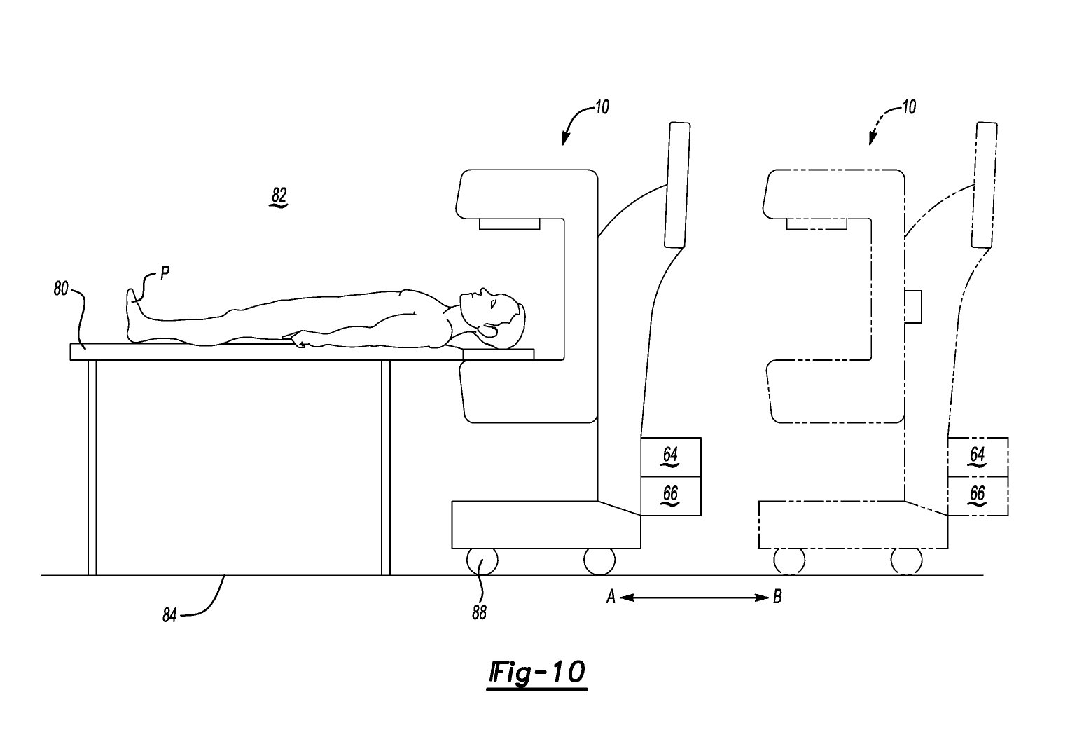

In another example shown in FIG. 10, a motor 64 moves the CT scanner 10 to position the CT scanner 10 in the scanning position A. During the pre-operative CT scan, the CT scanner 10 is located in the scanning position A. When the CT scanner 10 is no longer needed, the motor 64 is activated to move the CT scanner 10 to the remote position B. A controller 66 stores information about the movement of the CT scanner 10 during movement from the scanning position A to the remote position B. If an updated CT scan is needed during the surgical procedure, the controller 66 operates the motor 64 to move the CT scanner 10 from the remote position B to the scanning position A. That it, the controller 66 operates the motor 64 to exactly reverse the movement of the CT scanner 10 from the remote position B to the scanning position A such that the CT scanner 10 is located in the scanning position A based on the stored information.

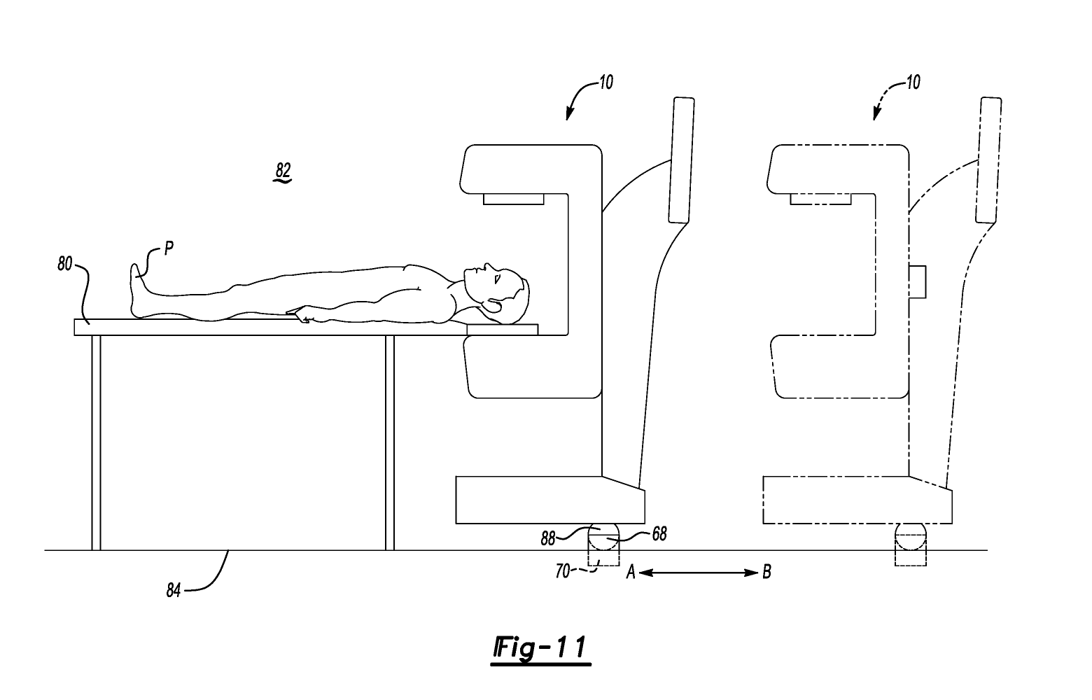

In another example shown in FIG. 11, a mechanical interlock 68 on the CT scanner 10 interacts with another mechanical interlock 70. The mechanical interlock 70 can be located on the table 80, in a room 82 or on a floor 84 (only the interlock 70 on the floor 84 is shown). Before the pre-operative CT scan, the CT scanner 10 is locked in the scanning position A by interacting the mechanical interlocks 68 and 70. After the pre-operative CT scan, the mechanical interlocks 68 and 70 are disengaged, and the CT scanner 10 is moved to the remote position B. If an updated CT scan is needed during the surgical procedure, the interlock features 68 and 70 are re-engaged, retaining the CT scanner 10 in the scanning position A.

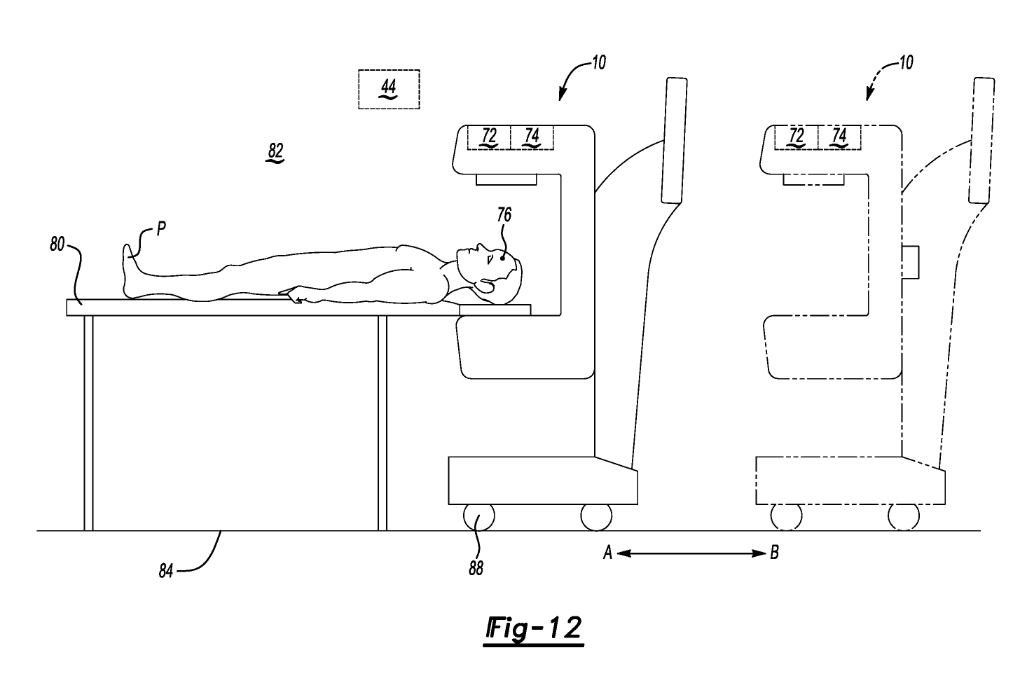

In another example shown in FIG. 12, the CT scanner 10 is tracked relative to an object 44. The object 44 can be a located in the room 82, on the table 80 or on the patient P. A sensor 72 is mounted on the CT scanner 10. The sensor 72 can be magnetic, optical, or any type of sensor. A controller 74 monitors the position of the sensor 72, and therefore the CT scanner 10, relative to the object 44. When the CT scanner 10 is in the scanning position A during the pre-operative CT scan, the controller 74 stores information about the relationship between the sensor 72 and the object 44. The CT scanner 10 is then moved to the remote position B. If an updated CT scan is needed during the surgical procedure, the CT scanner 10 is moved near the scanning position A. The controller 74 monitors the relationship between the sensor 46 on the CT scanner 10 and the object 44. When the controller 74 detects that the CT scanner 10 is in the scanning position A based on the relationship between the object 44 and the sensor 72, the controller 74 indicates that the CT scanner 10 is in the scanning position A. For example, the controller 74 can generate an audible noise or provide a visual indication.

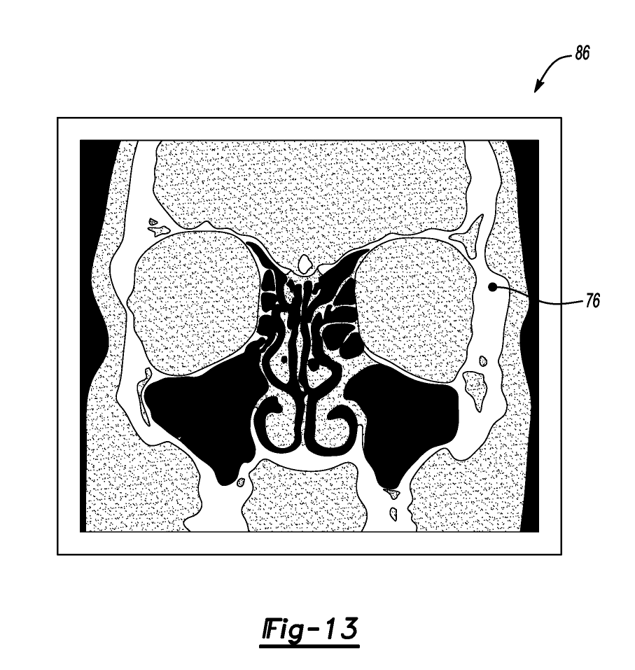

In another example, the CT scanner 10 takes a pre-operative CT scan while the CT scanner 10 is in the scanning position A. The CT scanner 10 is then moved away from the patient P to the remote position B. If an updated CT scan is needed, the CT scanner 10 is moved to the same general location that the CT scanner 10 was located in during the pre-operative CT scan (approximately the scanning position A). As shown in FIG. 13, the CT scanner 10 takes a single two dimensional x-ray 86 with a collimated x-ray source 20 that can be a lateral scout view x-ray or an AP (front) scout view x-ray. The two dimensional x-ray 86 is compared and correlated to a pre-operative x-ray image taken during the pre-operative three-dimensional CT scan. If the two dimensional x-ray 86 matches the pre-operative x-ray image, this indicates that the CT scanner 10 is located in the scanning position A. If the two dimensional x-ray 86 does not match or correlate with the pre-operative x-ray image, this indicates that the CT scanner 10 is not in the scanning position A and needs to be moved. By only taking a single x-ray to align the CT scanner 10, the patient P is exposed to fewer x-rays.

The pre-operative CT image and the updated CT image can be correlated by employing the marker 76, which is positioned on the patient P (such as on the face) or an object secured to the patient P, such as a headset. The marker 76 is at the same location during the pre-operative CT scan and the updated CT scan. The marker 76 can be a metal BB, a bead or can be air. When the pre-operative CT scan and any updated CT scans are taken, the marker 76 is shown on the display 36 in the three-dimensional CT image.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A CT scanner system comprising:
a CT scanner moveable between a scanning position and a remote position; and
an alignment feature that repeatably aligns the CT scanner in the scanning position.

2. The CT scanner system as recited in claim 1 wherein the alignment feature comprises a laser generating device on the CT scanner that generates a laser beam, wherein the laser beam contacts a location on a patient when the CT scanner is in the scanning position.

3. The CT scanner system as recited in claim 1 wherein the alignment feature includes a motor that moves the CT scanner from the scanning position to the remote position and a controller that stores information about movement of the CT scanner from the scanning position to the remote position and uses the information to move the CT scanner from the remote position to the scanning position.

4. The CT scanner system as recited in claim 1 wherein the alignment feature comprises a first interlock on the CT scanner and a second interlock in a room containing the CT scanner, wherein the first interlock and the second interlock interact to align the CT scanner in the scanning position.

5. The CT scanner system as recited in claim 4 wherein the second interlock is located on one of a floor and a table.

6. The CT scanner as recited in claim 1 wherein the alignment feature comprises a sensor on the CT scanner and a controller that determines a spatial relationship between the sensor and an object in a room containing the CT scanner when the CT scanner is initially in the scanning position.

7. The CT scanner as recited in claim 6 wherein the controller provides a signal when the controller detects the spatial relationship between the CT scanner and the object after the CT scanner has been moved from the scanning position.

8. The CT scanner as recited in claim 7 wherein the signal is one of an audio signal and a visual signal.

9. The CT scanner system as recited in claim 1 wherein the alignment feature comprises a marker on the patient, wherein an image of the marker in a pre-operative image and an image of the marker in an intra-operative image are aligned when the CT scanner is in the scanning position.

10. The CT scanner system as recited in claim 1 wherein the CT scanner includes an x-ray source that generates x-rays and an x-ray detector mounted opposite the x-ray source, and a CT scan is performable when the CT scanner is in the scanning position.

11. The CT scanner system as recited in claim 10 wherein the CT scanner includes a computer that stores pre-operative data and compares the pre-operative data to initial images of a partial intra-operative CT scan to define a volume of change in a patient, wherein the x-ray source is then collimated to focus collimated the x-rays towards the volume of change to obtain collimated x-ray data of the volume of change, and the computer uses the pre-operative data and the collimated x-ray data to generate an updated CT image.

12. A method of aligning a CT scanner, the method comprising the steps of:
moving a CT scanner between a scanning position and a remote position; and
repeatably aligning the CT scanner in the scanning position.

13. The method as recited in claim 12 wherein the step of repeatably aligning comprises generating a laser beam from a laser generating device on the CT scanner and directing the laser beam towards a location on a patient when the CT scanner is in the scanning position.

14. The method as recited in claim 12 including the step of storing information about movement of the CT scanner from the scanning position to the remote position and using the information to move the CT scanner from the remote position to the scanning position.

15. The method as recited in claim 12 wherein the step of repeatably aligning comprises interacting a first interlock on the CT scanner and a second interlock in a room to align the CT scanner in the scanning position.

16. The method as recited in claim 12 wherein the step of repeatably aligning comprises determining a spatial relationship between the CT scanner and an object in a room containing the CT scanner when the CT scanner is in the scanning position with a controller, moving the CT scanner from the scanning position to the remote position, then moving the CT scanner from the remote position towards the scanning position and providing a signal when the spatial relationship between the CT scanner and the object is detected.

17. The method as recited in claim 12 wherein the step of repeatably aligning comprises aligning an image of a marker in a pre-operative image with an image of a marker in an intra-operative image.

18. The method as recited in claim 12 including the steps of rotating a gantry about an axis of rotation to obtain a plurality of x-ray images and generating a three-dimensional CT image from the plurality of x-ray images.

19. The method as recited in claim 12 including the steps of performing a pre-operative CT scan of a patient and then moving the CT scanner from the scanning position to the remote position.

20. The method as recited in claim 12 including the steps of performing a pre-operative CT scan of the patient to obtain pre-operative data, obtaining initial images, comparing the pre-operative data to the initial images to determine a volume of change in the patient, collimating an x-ray source based upon the volume of change to direct x-rays towards at least the volume of change, performing a collimated intra-operative CT scan of the volume of change to obtain collimated x-ray data and reconstructing a CT image based upon the pre-operative data and the collimated x-ray data to create a fully updated CT image.
